(19) United States
(12) Patent Application Publication
(10) Pub. No.: US 2005/0105663 A1
(43) Pub. Date: May 19, 2005

(54) Apparatus for generating nuclear heat

(76) Inventor: Talbot Albert Chubb, Arlington, VA (US)

Correspondence Address: Melvin L. Crane, 318 South Cleveland Street, Arlington, VA, 22204-2038, US

(21) Appl. No.: 10/696,516

(22) Filed: Oct. 30, 2003

(51) Int. Cl. G21J 1/00

(52) U.S. Cl. 376/100

(57) ABSTRACT

A deuterium-fueled heat source that utilizes solid state electrolysis device(s) that deposit D atoms onto, and remove D atoms from, a metal reactor plate containing deuterium diffusion-impeding barriers.

### RELATED PATENT APPLICATON

This application is copending with a related patent application for a Process for Generating Nuclear Heat filed on the same date, which was 30 Oct. 2003, serial number

The invention relates to Disclosure Document Number 515131 filed in the U.S. Patent Office on 14 Jul. 2002 by applicant.

### FIELD OF THE INVENTION

This invention relates to heat generating devices and more particularly to heat generating devices in which deuterium participates in exothermic nuclear reactions in condensed matter. Further, the invention is directed to low energy nuclear reactions taking place in condensed matter, which includes radiationless cold nuclear fusion and other nuclear transmutations.

### SUMMARY OF THE INVENTION

The invention describes an apparatus which contains a containment enclosure made of steel, pierced with hermetically sealed electrical feed-through fittings, and which is filled with deuterium gas D₂. The enclosure contains a metal reactor plate capable of absorbing deuterium, and which supports diffusion flow of deuterium in response to an internal deuterium density gradient. The reactor plate is fabricated so as to contain thin internal nonmetallic layers parallel to its surface and of thickness such that the layers impede, but do not prevent deuterium diffusion flow within the plate. In a favored implementation of the invention, the two exterior faces of the reactor plate are each coated with a solid state electrolyte. Each solid electrolyte layer is overcoated with a metal foil which is capable of dissolving deuterium. Metal foil, solid electrolyte, and contacting surface of the reactor plate form an electrolysis cell. There is an inflow electrolysis cell through which deuterium flows before entering the reactor plate, and an outflow electrolysis cell through which deuterium flows after leaving the reactor plate. The rims of the reactor plate, the two electrolyte layers, and the two metal foils are coated with an electrical insulator, which constitutes an annular rim insulator. The annular rim insulator is penetrated at the metal plate's rim with an electrical conducting wire, which passes through one of the feed-through fittings so as to permit connection to an external source of voltage and current outside the containment enclosure. Separate electrical wires make contact with the two metal foils, and pass through the containment enclosure's wall through separate metal feed-through fittings. All wire passages through the walls of the containment enclosure are vacuum-tight sealed. A hermetic gas input tube penetrates the containment enclosure wall. The input tube is used to introduce D₂ gas into the cell during a preparation period during which a desired initial quantity of deuterium dissolves into the various metal components and a desired initial quantity of D₂ gas fills the Apparatus enclosure. The gas input tube can be sealed off before Apparatus use.

During operation of the Apparatus, D₂ gas is absorbed into the positive electrode of the front electrolysis cell. The absorbed deuterium passes through the front electrolysis cell and enters the front layer of the reactor plate, flows through the reactor plate where it is subject to scattering at the internal diffusion-impeding layers, mostly passes out the back surface of the reactor plate into the back electrolysis cell with its covering metal foil, and re-enters the gas volume of the Apparatus enclosure as D₂ gas. This deuterium circulation is driven by serial voltage potentials applied across the entrance and exit electrolysis cells. The scattering process converts some of the diffusing deuterium into a nuclearly active configuration. The nuclearly active configuration deuterium participates in exothermic nuclear reactions. Released nuclear energy converts into heat within the reactor plate. Subsequent heat transfer delivers the generated heat to a user application.

A one-electrolysis-cell version of the Apparatus omits the inflow electrolysis cell. In this one-cell version inflowing D₂ gas adsorbs directly onto the inflow face of the reactor plate and absorbs into the interior of the reactor plate. Two versions of the Apparatus replace the one or more diffusion inhibiting layers with a dispersion of diffusion-impeding non-metallic inclusions.

### OBJECTS OF THE INVENTION

It is therefore an object of the invention to provide a device from which nuclear energy is released and converted to heat within a reactor plate;

Another object of the invention is to provide heat from nuclear energy by use of nuclear reactions in which deuterium participates as a reactant;

Still another objective is to provide heat from nuclear energy without the emission of energetic particles, neutrons, or gamma radiation, such as accompanies heat generation in commercial nuclear power plants;

Yet another object is to provide heat from nuclear energy in a device that is small enough to be suitable for heating a room.

### BRIEF DESCRIPTION OF THE DRAWINGS

FIGS. 1, 2, and 4 are schematic cross sectional drawings illustrating two different assemblies that implement the invention;

FIG. 1 is an edge view of an assembly that supports left-to-right deuterium permeation through a reactor plate;

FIG. 2 is a front end view of the assembly shown in FIG. 1;

FIG. 3 is an approximate one-million-times-magnified scaled cross sectional view of a portion of FIG. 1 showing detail not shown in FIG. 1; and

FIG. 4 is an alternative assembly that supports upward deuterium flow through a reactor plate.

### DETAILED DESCRIPTION

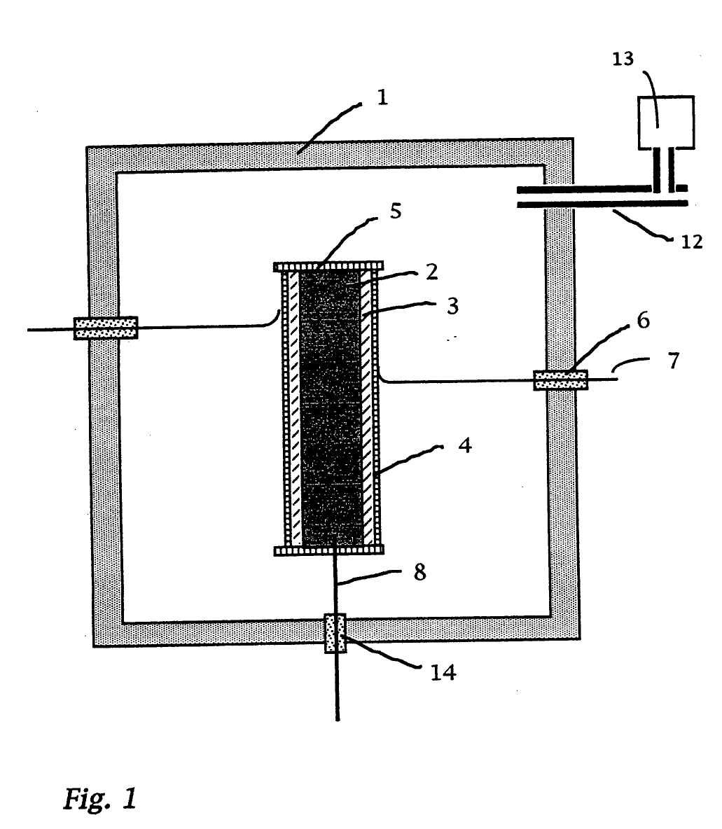

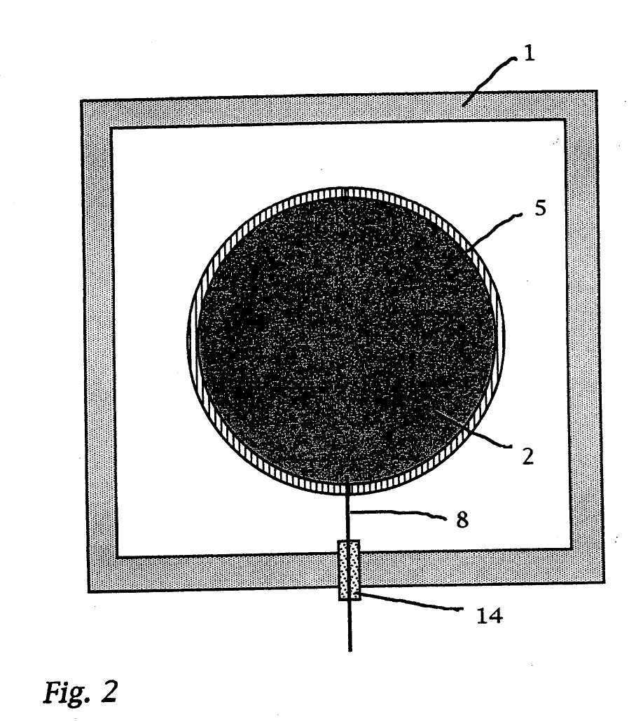

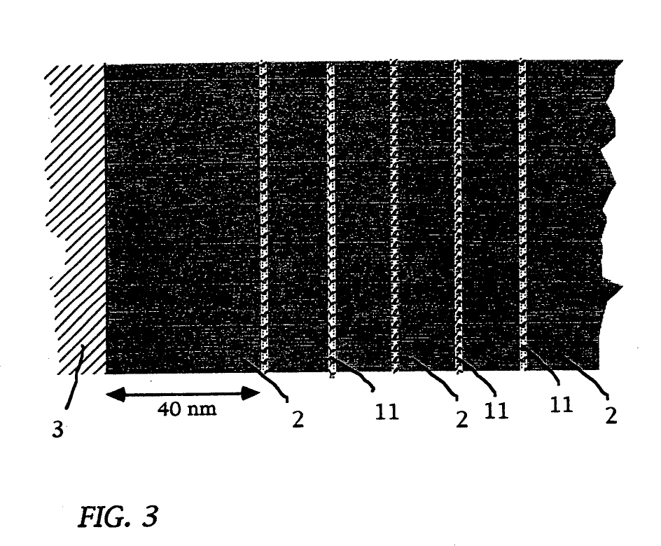

Now referring to FIGS. 1 and 2, pressure tight containment enclosure 1 is formed by aluminum, steel or other impervious metal, and contains an interior assembly comprising flat metal reactor plate 2 interfacing on its left and right side planar surfaces with left and right layers of solid electrolyte 3. The reference characters in FIGS. 1 and 2 identify the right side components, but apply equally to the left side components. Both left and right layers of solid electrolyte 3 make surface contact with left and right metal foils 4. Reactor plate 2 is made of Pd. Now referring to FIG. 3, within reactor plate 2 there is a left-side grouping of five layers 11 of CaO. The CaO layers are not shown in FIG. 1. The CaO layer closest to the left surface of reactor plate 2 is located about 40 nm inward and parallel to the left planar surface of the plate. The layers of CaO are 2 nm thick. Within the grouping, the CaO—CaO layer separation is about 18 nm. The thickness, separation, and distance of the CaO layers from the closest metal surface of reactor plate 2 are as taught by Y. Iwamura, M. Sakano, and T. Itoh, Jpn. J. Appl. Phys. 41A, pp. 4642-4650, (2002), by Y. Iwamura, T. Itoh, M. Sakano, and S. Kuribayashi, in ICCF10 Abstracts, Presentation Tu15, (2003)., and by T. Higashiyama, M. Sukano, H. Miyamaru, and A. Takahashi, ICCF10 Proceedings preprint, distributed through www.LENR-CANR.org, pp. 1-6, (2003). Iwamura et al. fabricated their test reactor plates, which have the desired internal layer construction, by starting with a plate of commercially pure Pd metal, coating the reactor plate with a sequence of five 2-nm layers of sputtered CaO, separated by four 18-nm layers of sputtered Pd metal, and topped with a 40-nm layer of sputtered Pd metal. The layers were deposited using argon ion beam sputtering. Left and right solid electrolyte layers 3 are deposited layers of poly ethylene oxide (PEO), containing deuterided phosphoric acid, as taught by Biberian and G. Lonchampt, Proc. ICCF9 (2002), in “Condensed Matter Nuclear Science”, ed. by Xing Z. Li (Tsinghua University Press, China, 2003) pp. 17-22. Each layer is about 1 mm thick and is a deuteron conductor. The hydrided version of the specified electrolyte has been used in the prior art in lithium batteries, where it operates between 70° C. and 120° C. Left and right electrolyte layers 3 are each covered with a contacting piece of metal foil 4. Left and right metal foils 4 are made of Pd or Pd-alloy, and are about 0.1 mm thick. The rim surfaces of reactor plate 2, left and right electrolyte layers 3, and left and right metal foils 4 are held in place by annular rim insulator 5, which may be of poly tetrafluoroethylene plastic (PTFE). The left and right hermetically sealed feed-through insulators 6 are sealed to left and right electrical wire leads 7. Left wire lead 7 makes contact with left metal foil 4, and right wire lead 7 makes contact with right metal foil 4. Left and right wire leads are made of Ni. Bottom wire lead 8 passes through feed-through insulator 14 and makes contact with reactor plate 2 by piercing theannular rim insulator 5, as shown in FIGS. 1 and 2. Bottom wire lead 8 is made of Ni. The bottom wire lead 8 also supports the sub-assembly comprising reactor plate 2, left and right electrolyte layers 3, left and right metal foils 4, and annular rim insulator 5. Gas supply tube 12 pierces a wall of the containment enclosure 1, and is used to fill containment enclosure 1 with D₂ gas prior to use, and to furnish pre-operation processing D₂ gas which is absorbed by the metal components during conditioning of the system prior to Apparatus operation. Square box 13 schematically represents a pressure transducer that produces an electrical output voltage which measures gas pressure inside containment enclosure 1. An example of an operating device uses an enclosure volume of about 10 cubic inches and an operating pressure of about 20 psia.

Prior to operation of the Apparatus, the Apparatus is heated to above about 70° C. and is filled with D₂ gas. During operation of the Apparatus, wire lead 8 may be connected to ground electrical potential, which is defined as reference potential V=0 volts. Left metal foil 4, left solid electrolyte layer 3, and left surface of metal plate 2 form a left electrolysis cell. The left electrolysis cell is the inflow electrolysis cell. Right metal foil 4, right solid electrolyte layer 3, and right surface of metal plate 2 form a right electrolysis cell. The right electrolysis cell is the outflow electrolysis cell. Left wire lead 7 is connected to an external power supply providing an electrical potential V_{L}, which is positive relative to the left cell zero-current cell potential V_{Lo}, thereby polarizing the left cell so as to drive a deuterium permeation flow toward the right. Right wire lead 7 is connected to an external power supply providing an electrical potential V_{R}, which is negative relative to the right cell zero-current cell potential V_{Ro}, thereby polarizing the right cell so as to drive a deuterium permeation flow also toward the right. As taught by Biberian and Lonchampt, current flow through left electrolyte removes deuterium dissolved in left metal foil 4 and deposits deuterium onto metal plate 2, which plate absorbs the deposited deuterium. As taught by Biberian and Lonchampt, left-to-right current flow through right electrolyte desorbs deuterium from metal plate 2 and deposits deuterium onto right metal foil 4, which foil absorbs the deuterium. Concurrently D₂ gas dissociates on the left surface of left metal foil 4, and desorbs from the right surface of right metal foil 4 into the gas.

Absorption of deuterium on the left surface of reactor plate 2 and concurrent desorption of deuterium from the right side of reactor plate 2 drives a left-to-right permeation flow of deuterium through reactor plate 2. This permeation flow resembles that used in the studies of Iwamura et al. (2002 and 2003) and Higashiyama et al. (2003), which studies have demonstrated deuterium participation in exothermic nuclear reactions. In “The dd Cold Fusion-Transmutation Connection” by T. A. Chubb, ICCF10 Proceedings preprint, distributed through www.LENR-CANR.org, pp. 1-15, (2003a), a quantum mechanics wave equation-wave function model explains how the prescribed permeation flow leads to exothermic nuclear reactions. The model assumes that impeded deuterium permeation flow creates a nuclearly active configuration of wavelike deuterium, which behaves much like the conduction electron medium in a metal. Quantum mechanics uses the term “Bloch function” to described the deuterium configuration. The conduction electrons in a metal have a similar delocalized wavelike form and carry a low resistance conduction current flow in response to a voltage potential difference across a metal crystal. Similarly, wavelike deuterium is viewed as carrying a low resistance deuterium conduction permeation flow in response to a difference in the chemical potential of wavelike deuterium across a metal crystal.

The total deuterium permeation flow is modeled as being partitioned between a relatively large diffusion flow of non-nuclearly-active interstitial deuterium within the metal and a relatively small conduction flow carried by nuclearly-active wavelike deuterium. The normal form of deuterium in a metal is the non-nuclearly-active interstitial configuration. The normal diffusion flow is driven by a concentration gradient of deuterium in self-trapping potential wells. The normally occupied potential wells in Pd metal are known to be centered on the octahedral sites of the face-centered cubic (fcc) metal lattice. The conduction flow is modeled as being carried by wavelike deuterons occupying shallower, non-self-trapping potential wells. These wells are believed to be centered on the tetrahedral sites of the fcc metal lattice, as explained in “LENR: Superfluids, Self-Trapping and Non-Self-Trapping States” T. A. Chubb, ICCF10 Proceedings preprint, distributed through www.LENR-CANR.org, pp. 1-4, (2003b). At each of the CaO diffusion-impeding layers there is a scattering of both types of deuterium. The scatterings are modeled as reversible scatterings of individual deuterons between self-trapping and non-self-trapping sites. Reversibility requires that a fraction of the normally diffusing deuterons scatter into wavelike deuterons when they cross a diffusion-impeding layer. The resulting wavelike deuterons in the non-self-trapping sites are the nuclearly reactive component which, in the Iwamura studies, spreads out and participates in exothermic nuclear reactions on the metal surface, releasing heat. The nuclear reactions demonstrated by Iwamura et al. and Higashiyama et al. are ¹³³Cs+8D→¹⁴¹Pr+50.5 MeV and ⁸⁸Sr+8D→⁹⁶Mo+˜53.5 MeV.

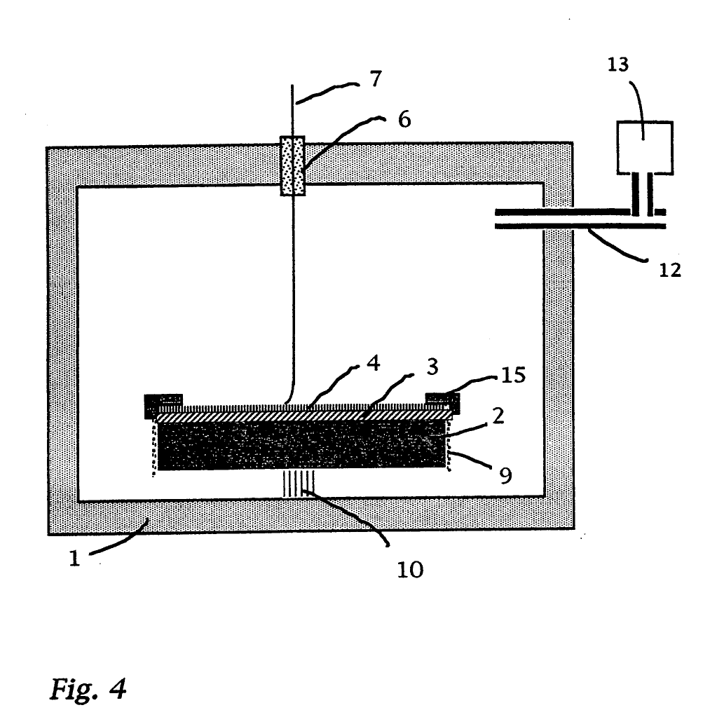

Now referring to FIG. 4, pressure tight containment enclosure 1 contains an interior assembly designed to provide an upward deuterium permeation flow through reactor plate 2. In FIG. 4, reactor plate 2 is coated on its annular rim surface by insulator coating 9. Annular insulator coating 9 is made of a non-porous material such as PTFE. Reactor plate 2 is made of Pd metal and contains internally a grouping of diffusion-impeding CaO layers near its bottom planar surface. These internal layers are configured as described in FIG. 3. Reactor plate 2 is supported from the bottom surface of containment enclosure 1 by metal cylinder 10, which is of lesser diameter than reactor plate 2. As a result, a portion of the bottom surface of reactor plate 2 is exposed to D₂ gas within containment enclosure 1 during Apparatus use. Reactor plate 2 makes contact with and is covered by solid electrolyte layer 3. Solid electrolyte layer 3 is made of poly ethylene oxide containing deuterided phosphoric acid. Solid electrolyte layer 3 makes contact with and is covered by metal foil 4, which is made of Pd metal. Metal foil 4 is positioned by annular positioning fixture 15, which is made of PTFE. The top surface of reactor plate 2, solid electrolyte layer 3 and metal layer 4 constitute an outflow electrolysis cell. Containment enclosure 1 is made of metal and is connected to electrical ground potential, designated V=0 volts. Wire lead 7, which is made of Ni, passes through feed-through insulator 6 to make contact with metal foil 4. During Apparatus use, wire lead 7 is connected externally to an electrical power supply that keeps metal foil 4 at a potential V which is more negative than the zero-current cell potential Vₒ. Gas supply tube 12 is used to supply D₂ gas to the interior of containment enclosure 1 during initial preparation of the Apparatus prior to heat generation. Square box 13 schematically represents a pressure transducer that produces an electrical output voltage which measures gas pressure inside containment enclosure 1.

During operation of the Apparatus as illustrated in FIG. 4, D₂ gas within containment enclosure 1 dissociates on the exposed portion of the bottom surface of reactor plate 2. It is known from the prior art that D₂ gas dissociates into atom form when adsorbed onto clean Pd-like metals. The resulting surface atoms are absorbed into the metal of reactor plate 2. At the top surface of reactor plate 2, surface deuterium desorbs from reactor plate 2 and enters solid electrolyte 3 as deuterium ions. With the potential of metal foil maintained at V<Vₒ, D⁺ ion current flows through solid electrolyte 3 and deuterium is absorbed into the bottom surface of metal foil 4. Deuterium desorbs from the top surface of metal foil 4 as D₂ gas. The resulting upward permeation flow through reactor metal 2 creates nuclearly active deuterium as previously described.

Many modifications and variations of the invention are possible in light of the above teachings. Among these is that of replacing the planar sequence of component layers with a cylindrical sequence of the same functional elements. In another option the unidirectional left-to-right or upward deuterium permeation flows within reactor plate 2 are replaced with back and forth deuterium permeation flows by using a power supply or supplies that repeatedly alternate the potentials applied to wire leads(s) 7 between values more positive and less positive than the zero-current cell potentials. Also, it is well known in the art of fuel cell technology and in the physics of metal hydrogen systems that one can coat a metal's surface with fine Pd powder or Pd—Ag alloy powder, thereby increasing the effective surface area for absorption of hydrogen into the metal's bulk. Also, use of Pd coatings on a metal's de-oxidized surface can permit absorption of hydrogen into a metal's bulk for metals which form oxides that otherwise block absorption of hydrogen. Use of such surface treatments on the metal foil(s) and/or on the reactor plate, and use of metals other than Pd or Pd alloys for the foil(s) and/or reactor plate within the Apparatus should be considered as within the scope of the invention. Furthermore, use of internal non-metallic layers made of materials other than CaO within a reactor plate have been taught by Iwamura et al. The number, placement, uniformity, and thickness of the internal non-metallic layers can be widely varied provided that deuterium permeation is not prevented, and provided that the impeding of the deuterium permeation flow is sufficient to scatter amounts of deuterium into the nuclearly reactive configuration that are comparable to, or greater than the amounts achieved by Iwamura et al. (2002). For example, inclusion of both a left and right grouping of diffusion-impeding layers within reactor plate 2 could be used in conjunction with back and forth deuterium permeation flow through the reactor plate 2 of FIG. 1. Also, a distribution of non-metallic inclusions resembling fragments of the diffusion-impeding CaO layers is within the scope of the invention provided that the impeding of deuterium permeation flow is sufficient to scatter amounts of deuterium into the nuclearly reactive state that are comparable to or greater than the amounts achieved by Iwamura et al. (2002). Addition of voltage control circuitry using signals from pressure transducer 13 together with temperature readings as a basis for setting the electrolysis cell voltages should be considered as within the scope of the invention. It is therefore to be understood that within the scope of the appended claims the invention may be practiced otherwise than as specifically described.

1. An apparatus for generating heat by exothermic nuclear reactions in which reactions deuterium participates, and in which during use of the apparatus deuterium flows out of an electrically polarized solid-electrolyte layer into a metal reactor plate, and in which apparatus deuterium flows out of the metal plate into a second polarized solid-electrolyte layer, with the reactor plate containing at least one diffusion-impeding non-metallic layer.

2. The apparatus of claim 1 in which at least one diffusion-impeding layer within the reactor plate is made of CaO.

3. The apparatus of claim 1 in which the metal reactor plate is made of metal selected from a group comprising Pd and Pd alloy.

4. The apparatus of claim 1 in which the solid-electrolyte layers are made of poly ethylene oxide (PEO), containing deuterided phosphoric acid.

5. An apparatus for generating heat by exothermic nuclear reactions in which reactions deuterium participates, and in which during use of the apparatus deuterium gas is adsorbed onto the inflow surface of a metal reactor plate and is absorbed into the reactor plate, from the reactor plate deuterium flows out of an outflow surface of the metal reactor plate into an electrically polarized solid-electrolyte layer, in which the reactor plate contains at least one diffusion-impeding non-metallic layer.

6. The apparatus of claim 5 in which at least one diffusion-impeding layer within the reactor plate is made of CaO.

7. The apparatus of claim 5 in which the metal reactor plate is made of metal selected from a group comprising Pd and Pd alloy.

8. The apparatus of claim 5 in which the solid-electrolyte layer is made of poly ethylene oxide (PEO), containing deuterided phosphoric acid.

9. An apparatus for generating heat by exothermic nuclear reactions in which reactions deuterium participates, and in which during use of the apparatus deuterium flows out of an electrically polarized solid-electrolyte layer into a metal reactor plate, and in which apparatus deuterium flows out of the metal plate into a second polarized solid-electrolyte layer, with the reactor plate containing a dispersion of diffusion-impeding non-metallic inclusions.

10. The apparatus of claim 9 in which non-metallic inclusions within the reactor plate are made of CaO.

11. The apparatus of claim 9 in which the metal reactor plate is made of metal selected from a group comprising Pd and Pd alloy.

12. The apparatus of claim 9 in which the solid-electrolyte layers are made of poly ethylene oxide (PEO), containing deuterided phosphoric acid.

13. An apparatus for generating heat by exothermic nuclear reactions in which reactions deuterium participates, and in which during use of the apparatus deuterium gas is adsorbed onto the inflow surface of a metal reactor plate and is absorbed into the reactor plate, and from the reactor plate deuterium flows out of the outflow surface of the metal reactor plate into an electrically polarized solid-electrolyte layer, with the reactor plate containing a dispersion of diffusion-impeding non-metallic inclusions.

14. The apparatus of claim 13 in which in which the non-metallic inclusions within the reactor plate are made of CaO.

15. The apparatus of claim 13 in which the metal reactor plate is made of metal selected from a group icomprising Pd and Pd alloy.

16. The apparatus of claim 13 in which the solid-electrolyte layer is made of poly ethylene oxide (PEO), containing deuterided phosphoric acid.
